(19) United States
(12) Patent Application Publication
(10) Pub. No.: US 2013/0163272 A1
(43) Pub. Date: Jun. 27, 2013

(54) USER INTERFACE LIGHTING APPARATUS

(71) Applicant: TouchSensor Technologies, LLC, Wheaton, IL (US)

(72) Inventors: Mark Burleson, Elburn, IL (US); Andrew J. Livingston, North Aurora, IL (US)

(73) Assignee: TOUCHSENSOR TECHNOLOGIES, LLC, Wheaton, IL (US)

(21) Appl. No.: 13/722,319

(22) Filed: Dec. 20, 2012

Related U.S. Application Data
(60) Provisional application No. 61/579,728, filed on Dec. 23, 2011.

(51) Int. Cl. F21V 8/00

(52) U.S. Cl. CPC G02B 6/0096
USPC 362/555

(57) ABSTRACT

A user interface panel includes a user interface substrate, an electronics carrier and a light pipe disposed between the user interface substrate and electronics carrier. A reverse mount, side emitting LED is disposed through an aperture in the electronics carrier so that the LED can emit light into the light pipe.

### BACKGROUND OF THE INVENTION

A touch-responsive user interface (UI) can include an electronics carrier bearing touch responsive switches or sensors and a UI substrate defining one or more operable touch surfaces corresponding to the touch-responsive switches or sensors, wherein the electronics carrier is adhered or otherwise attached to the side of the UI substrate opposite the touch surfaces. In operation, the touch-responsive switches or sensors detect proximity or touch of a stimulus, for example, a finger or other conductive object, to the corresponding touch surfaces and provide an output indicative of a touch or no-touch condition, as would be understood by one skilled in the art.

A touch-responsive UI also can include backlighting features to illuminate the touch surfaces and/or other portions of the UI substrate. Known means for backlighting typically involve projecting light directly or indirectly (using a reflector or light guide) through the electronics carrier at each location to be backlit or projecting light into a light pipe positioned between the electronics carrier and the UI substrate at each location to be backlight.

In embodiments wherein light is projected through the electronics carrier, at least the portion of the electronics carrier through which the light is projected must be perforated or sufficiently transparent or translucent to allow adequate light transmission there through, as would be understood by one skilled in the art. Use of such materials or techniques can be costly and add complexity to the manufacturing process.

In embodiments using light pipes, each light pipe typically takes the form of a wedge having a cross-section defining a right angle, a hypotenuse, a long side and a short side. The surface of the wedge corresponding to the long side abuts the UI substrate. The portion of the electronics carrier under which the light pipe is disposed is cut on three sides so that it may deflect in a direction away from the UI substrate in order to accommodate the varying thickness of the wedge. An LED mounted to the electronics carrier adjacent the surface of the wedge corresponding to the short side projects light into the light pipe through that surface. Such embodiments involve relatively complex electronics carrier geometry and assembly techniques.

### BRIEF DESCRIPTION OF THE DRAWINGS

FIG. 1 is a side elevation view of an illustrative UI 10 including a UI substrate 12, a light pipe 14 attached to UI substrate 12, an electronics carrier 16 attached to light pipe 14 and a reverse mount, right angle, surface mount LED 22 mounted to and penetrating electronics carrier 16 through an aperture 18 therein and oriented to project light into light pipe 14; and

FIG. 2 is a perspective view of electronics carrier 16 showing LED 22 disposed through aperture 18 in electronics carrier 16, oriented to project light into light pipe 14 and connected to electrical circuit traces on electronics carrier 16.

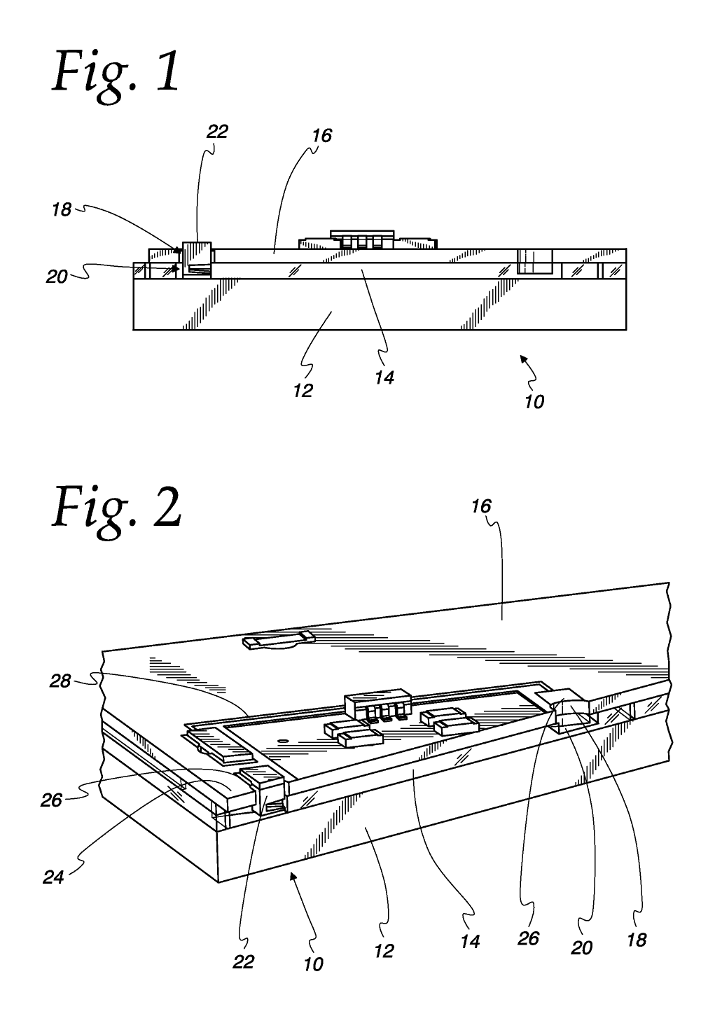

### DETAILED DESCRIPTION OF THE DRAWINGS

The drawings show an illustrative UI 10. UI 10 includes a UI substrate 12. UI substrate 12 may be made of any suitable material, as would be understood by one skilled in the art. For example, UI substrate 12 could be made of glass or plastic.

A light pipe or light pipe material 14 can be attached using adhesives or otherwise to a rear surface of UI substrate 12. Light pipe 14 may be made of any suitable material, for example, an acrylic material, and take any suitable form, as would be understood by one skilled in the art. As shown in the drawings, light pipe 14 may have a substantially uniform cross-section.

An electronics carrier 16 can be attached using adhesives or otherwise to a rear surface of light pipe 14. Electronics carrier 16 may be made of any suitable material and take any suitable form, as would be understood by one skilled in the art. For example, electronics carrier 16 could be a printed wiring board made of FR4 or another material having similar or suitable properties. Alternatively, electronics carrier 16 could be a flexible circuit carrier or another suitable circuit platform.

Electronics carrier 16 could bear various electrical and/or electronic components as might be dictated by a particular application. For example, electronics carrier 16 could bear touch sensors for sensing proximity or touch by a stimulus, for example, a human finger or other conductive object, to a corresponding touch surface defined by a corresponding portion of a front surface of UI substrate 12. Such touch sensors could include one or more sensing electrodes, as well as related circuit components for providing signals to and processing signals from the sensing electrodes. One suitable form of touch sensor is the TS-100 touch sensor produced by TouchSensor Technologies, LLC of Wheaton, Ill., and described in U.S. Pat. No. 6,320,282. Other forms of touch sensor, for example, capacitive touch sensors, could be used as well. In embodiments using touch sensors, there preferably is no air gap or at most a minimal air gap between UI 12 and light pipe 14 and between light pipe 14 and electronics carrier 16.

Electronics carrier 16 includes an aperture or perforation 18 there through. Light pipe 14 may have a coextensive aperture or penetration there through or a coextensive cavity 20 of sufficient depth therein, as would be understood by one skilled in the art. A reverse mount, right angle (side emitting) LED 22 or similar light emitting device can be inserted through aperture 18 in electronics carrier 16 and into aperture or cavity 20 of light pipe 14 so that the light emitting portion of LED 22 can project light into light pipe 14. In some embodiments, LED 22 could be inserted through aperture 18 in electronics carrier 16 laterally spaced from an edge of light pipe 14 such that the light emitting portion of LED 22 can project light through an exterior edge of light pipe 14, instead of through an interior edge (as might be defined by aperture or cavity 20) of light pipe 14. In such an embodiment, aperture 20 in light pipe 14 could be unnecessary and could be omitted. An optical gel or optical couplant could, but need not, be provided between LED 22 and light pipe 14 to enhance the optical coupling therebetween.

LED 22 could be mounted and electronically connected to bonding pads 26 or other circuitry or traces 28 disposed on a rear surface 24 of electronics carrier 16. Electronics carrier 16 could, but need not, bear electronic components and electrical traces, etc., on the front side thereof, as well.

Because both the light emitting portion of LED 22 and light guide 14 are on the UI substrate-side of electronics carrier 16, light need not be projected through electronics carrier 16. As such, electronics carrier 16 need not be transparent or translucent or have transparent or translucent portions (although it could). Instead, electronics carrier 16 can be substantially opaque at least in any region corresponding to any portion of UI substrate 12 that may be backlit by LED 22. Also, because LED 22 is mounted to the rear surface of electronics carrier 16, it may be relatively easily replaced in the event it fails, without the need for extensive disassembly of user interface 10. Disassembly of user interface 10 after initial assembly could be difficult, if not impossible.

1. An apparatus comprising:
a light pipe;
a user interface substrate attached to a first surface of said light pipe;
an electronics circuit carrier attached to a second surface of said light pipe, said electronics carrier defining an aperture;
a reverse mount, right angle LED disposed within said aperture of said electronics carrier, said LED adapted to project light directly into said light pipe from an edge of said light pipe,
said LED electrically connected to circuitry disposed on a surface of said electronics carrier.

2. The apparatus of claim 1 wherein said light pipe defines an aperture therethrough or a cavity extending inwardly from said second surface thereof, said cavity or aperture defining a sidewall, said LED extending into said cavity or aperture and said sidewall comprising said edge of said light pipe.

3. The apparatus of claim 1 wherein said electronics carrier is substantially opaque.

4. The apparatus of claim 1 wherein said LED is adapted for removal from said electronics carrier and said light pipe without removal of said electronics carrier from said light pipe.

5. The apparatus of claim 1 wherein said first surface of said light pipe is substantially parallel to said second surface of said light pipe.

6. The apparatus of claim 1 wherein said light pipe has a substantially uniform cross section.

7. The apparatus of claim 1 further comprising at least one touch sensor disposed on said electronics carrier, said touch sensor adapted to sense proximity or touch of a stimulus to a corresponding portion of said user interface substrate.

8. The apparatus of claim 1 further comprising an optical couplant between said LED and said light pipe.

9. The apparatus of claim 1 wherein said edge is substantially perpendicular to said first surface and said second surface of said light pipe.

10. The apparatus of claim 1 wherein said LED is electrically connected to a surface of said electronics carrier opposite said light pipe.

11. The apparatus of claim 1 wherein said electronics carrier is substantially opaque in a region corresponding to a portion of said UI substrate that is backlit by said LED.
